(19) United States
(12) Patent Application Publication
(10) Pub. No.: US 2022/0250794 A1
(43) Pub. Date: Aug. 11, 2022

(54) MODULAR CONTAINERS

(71) Applicant: ADVANTUS, CORP., Jacksonville, FL (US)

(72) Inventors: David A. Schenker, Cedarburg, WI (US); Chris Pitzo, Pewaukee, WI (US)

(73) Assignee: ADVANTUS, CORP., Jacksonville, FL (US)

(21) Appl. No.: 17/172,219

(22) Filed: Feb. 10, 2021

(51) Int. Cl. B65D 21/02; B65D 43/02

(52) U.S. Cl. CPC B65D 21/0204; B65D 43/0202; B65D 2543/00537; B65D 2543/00842; B65D 2543/00527; B65D 2543/00194

(57) ABSTRACT

A container assembly includes a first container having a sidewall, a first connector, and a second connector such that the first connector and the second connector each extend away from the sidewall. A second container has a sidewall, a first connector, and a second connector such that the first connector and the second connector each extend away from the sidewall. Each first connector has an interior surface that defines a hole that is centered about a first center axis and a ridge radially inwardly extending from the interior surface into the hole, and each second connector has an exterior surface that engages with the interior surface of one of the first connectors.

### FIELD

The present disclosure relates to interlocking modular storage containers. More specifically, the present disclosure relates to storage containers of varying sizes that can be connected and disconnected from each other depending on the desired use.

### BACKGROUND

Presently, conventional storage containers are used to store objects. In one example, conventional storage containers are stackable such that multiple objects can be stored within a small footprint. In this example, the containers are connected to each other in a vertical configuration. However, stacked containers can obstruct or prevent a person from observing the contents in each container. Accordingly, in certain examples, it may be advantageous to connect the containers together in a side-by-side configuration.

The inventors of the present application endeavored to develop containers for storing objects and that can be coupled together in a side-by-side configuration. Accordingly, the inventors developed the modular and reconfigurable containers described herein below.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

In certain examples, a container assembly includes a first container having a sidewall, a first connector, and a second connector such that the first connector and the second connector each extend away from the sidewall. A second container has a sidewall, a first connector, and a second connector such that the first connector and the second connector each extend away from the sidewall. The first connector of the first container is mated with the second connector of the second container and the second connector of the first container is mated with the first connector of the second container to thereby couple the first container to the second container. Each first connector has an interior surface that defines a hole that is centered about a first center axis and a ridge radially inwardly extending from the interior surface into the hole, and each second connector has an exterior surface that engages with the interior surface of one of the first connectors.

In certain examples, the container includes a first sidewall and an opposite second sidewall. A first connector laterally extends from the first sidewall, and the first connector is configured to be mated to a second connector of another container. A second connector laterally extends from the first sidewall, and the second connector is spaced apart from the first connector. The second connector is configured to be mated to a first connector of another container. A first lip extends from the first sidewall and defines a first channel, and a second lip extends from the second sidewall and defines a second channel. The container has a cavity configured to receive objects therein and an opening into the cavity. A cover is selectively longitudinally moved to cover the opening, and the cover has a first edge received in the first channel and an opposite second edge received in the second channel. As the cover is moved, the first edge is moved in the first channel and the second edge is moved in the second channel.

Various other features, objects, and advantages will be made apparent from the following description taken together with the drawings.

### BRIEF DESCRIPTION OF THE DRAWINGS

The present disclosure is described with reference to the following Figures. The same numbers are used throughout the Figures to reference like features and like components.

FIG. 1 is a perspective view of example containers of the present disclosure. The containers are depicted decoupled from each other.

FIG. 2 is a perspective view of the containers of FIG. 1 coupled to each other.

FIG. 3 is a cross-sectional view along line 3-3 on FIG. 2.

FIG. 4 is an enlarged view within line 4-4 on FIG. 3.

FIG. 5 is a top-down plan view of multiple containers coupled together.

FIG. 6 is a top-down plan view of the containers of FIG. 5 decoupled from each other.

### DETAILED DESCRIPTION

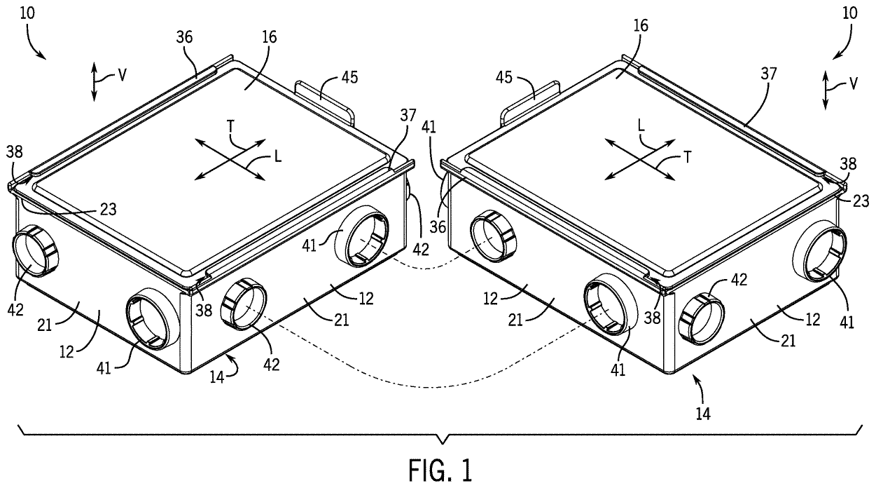

FIGS. 1-3 depicts example containers of the present disclosure. The containers 10 are configured to contain and hold various objects. In one example, the containers 10 hold washers, nuts, bolts, hooks, and/or other small hardware pieces. In another example, the containers 10 hold glitter, pipe cleaners, stencils, and/or other craft or scrapbooking materials and tools.

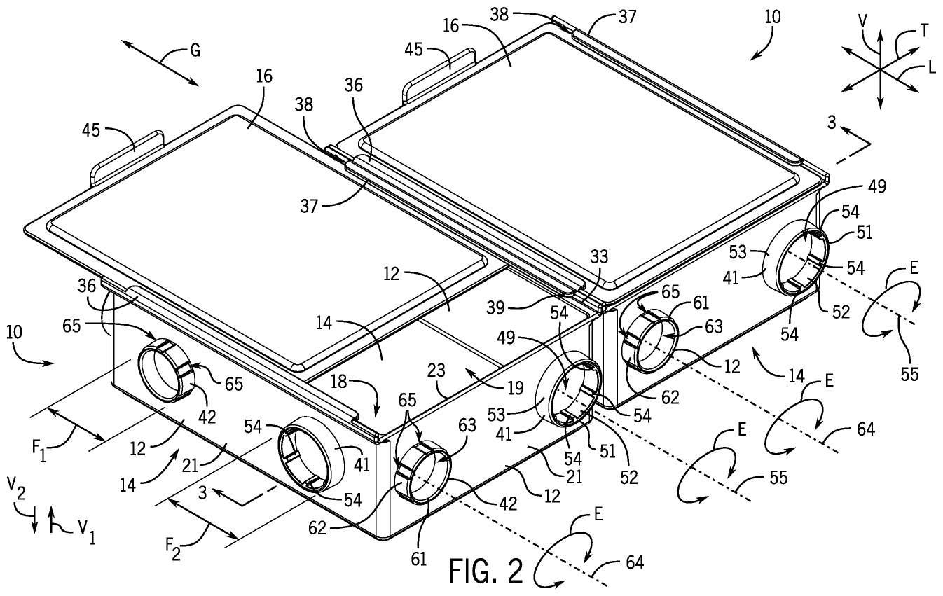

The containers 10 can vary in shape and/or size to accommodate different objects therein. Generally, each container 10 forms a three-dimensional shape with a cavity 18 therein (FIG. 2). The containers 10 depicted in FIGS. 1-3 are rectangular. In other examples, the containers 10 are octagonal prisms. The containers 10 are formed from any suitable material such as plastic, wood, paper, and metal.

Each container 10 has a plurality of sidewalls 12, a bottom wall 14, and a cover 16. The sidewalls 12, the bottom wall 14, and the cover 16 define the cavity 18. The container 10 also has an opening 19 through which a user passes the objects into and out of the cavity 18. The cover 16 is slidable relative to the sidewalls 12 to completely or partially cover the opening 19 (described further herein). The container 10 generally extends longitudinally (see longitudinal axis L) between a first end and a second end, laterally (see lateral axis T) between a first side and a second side, and vertically (see vertical axis V) between a top and a bottom (see FIG. 2).

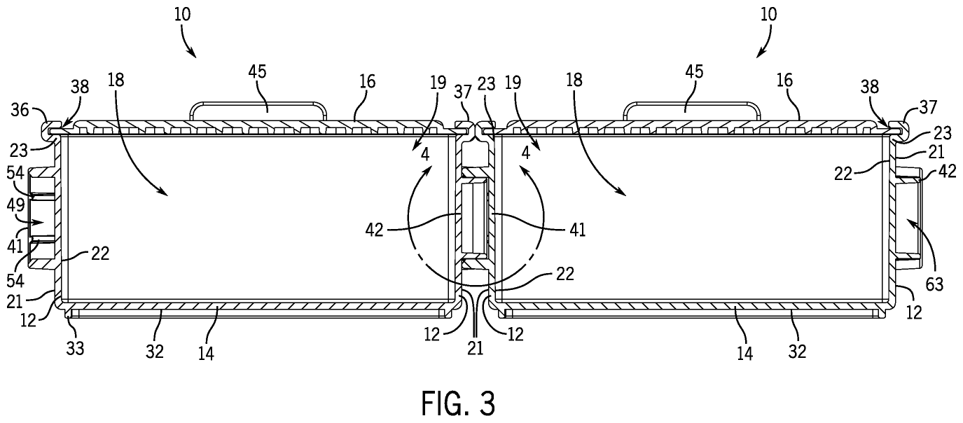

The sidewalls 12 define the sides and the ends of the container 10, and the sidewalls 12 are generally rectangular plates that vertically extend away from the bottom wall 14. Each sidewall 12 has an exterior surface 21, an opposite interior surface 22 (FIG. 3), and a top edge 23. One or more connectors 41, 42 extend or protrude from the exterior surfaces 21 of the sidewalls 12 (FIG. 2), and the connectors 41, 42 are for connecting the container 10 to another container 10. Specifically, the connectors 41, 42 of a first container 10 mate or couple to connectors 41, 42 of a second container 10 such that the containers 10 can be coupled together in side-by-side orientation (FIG. 2). The connectors 41, 42 are described herein below in greater detail.

The bottom wall 14 defines the bottom of the container 10, and the bottom wall 14 is generally a planar rectangular plate extending between the sidewalls 12. The bottom wall 14 has an exterior surface 32 with one or more standoffs 33 vertically extending away from the exterior surface 32 (FIG. 3). The standoffs 33 contact a support structure (e.g., table) on which the container 10 is placed and elevate the exterior surface 32 of the bottom wall 14 vertically above the support surface. In the example depicted in FIGS. 1-3, the standoff 33 continuously extends along the perimeter of the bottom wall 14.

As noted above, the cover 16 is for selectively covering the opening 19 (FIG. 2). The outer perimeter of the cover 16 is positioned along the top edges 23 of the sidewall 12, and the cover 16 is generally a planar rectangular plate. The cover 16 is coupled to the container 10 with any suitable device such as fasteners and clips. In the example depicted, the cover 16 is coupled to the container 10 with a pair of lips, namely a first lip 36 and a second lip 37, that retain the cover 16 on the container 10 while permitting the cover 16 to slide relative to the opening 19. The lips 36, 37 are generally U-shaped, and each lip 36, 37 defines a channel 38 that slidably receives the two edges of the cover 16 (FIG. 3).

Each lip 36, 37 is positioned along the top edge 23 of two opposing sidewalls 12. For example, the first lip 37 extends along the top edge 23 of the sidewall 12 that defines the first side of the container 10 and the second lip 37 extends along the top edge 23 of the sidewall 12 that defines the second side of the container 10. To connect the cover 16 to the container 10 the cover 16 is longitudinally slid in a direction from one end toward the other end of the container 10 (see arrow G on FIG. 2) such that the cover 16 slides along the top edge 23 of one or more sidewalls 12 and the sides of the cover 16 slide in the channels 38. Thus, the lips 36, 37 retain the cover 16 on the container 10 and the cover 16 can be longitudinally slid (see arrow G on FIG. 2) to thereby partially or completely uncover the opening 19. Note that FIG. 2 depicts a first container 10 with a cover 16 completely covering the opening 19 of the first container 10 and a second container 10 with a cover 16 partially covering the opening 19 of the second container 10.

In certain examples, friction forces between the cover 16, the lips 36, 37, and/or the top edges 23 of the sidewalls 12 prevent the cover 16 from inadvertently sliding out of the channels 38 and off the container 10. In this example, the user must apply a pushing or pulling force to overcome the friction forces and thereby slide the cover 16.

In another example, one or more ribs 39 (FIG. 2) within the channels 38 interact with one or more ribs (not shown) on the cover 16 to thereby prevent the cover 16 from inadvertently sliding out of the channels 38 and off the container 10. The ribs 39 in the channel 38 vertically extend away from the top edge 23 of the sidewall 12 in a first vertical direction V1 (FIG. 2), and the ribs (not shown) on the cover 16 extend away from the cover 16 in a second vertical direction V2 (FIG. 2). Thus, as the sides of the cover 16 are slid in the channel 38, the rib on the cover 16 contacts the rib 39 in the channel 38 thereby stopping movement of the cover 16. To continue moving the cover 16, the user applies a pushing or pulling force (arrow G on FIG. 2) to thereby force the ribs past one another (e.g., under additional forces the ribs elastically deform or the cover 16 bends/deflects such that the ribs slide past one another). The position of the rib on the cover 16 and/or the rib 39 in the channel 38 may correspond to a position of the cover 16 relative to the opening 19 (e.g., the ribs may be positioned such that when the ribs contact each other the opening 19 is halfway covered by the cover 16). In certain examples, the cover 16 includes a tab 45 at one end of the cover 16 that contacts the sidewall 12 to thereby stop or prevent further longitudinal movement of the cover 16. The tab 45 also functions as a handle for the user to engage when moving the cover 16.

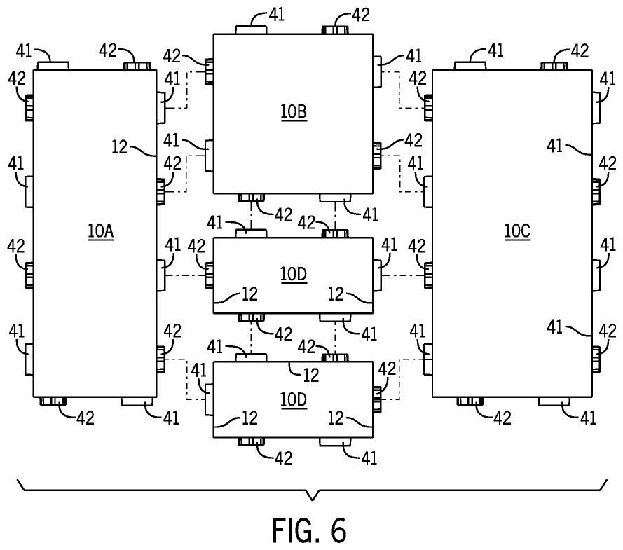

As noted above, the connectors 41, 42 are for coupling the containers 10 to each other. FIGS. 1-2 depict a first container 10 coupled to a second container 10. The containers 10 in these figures are similar in size and shape. FIGS. 5-6 depict a variety of differently sized and shaped containers 10A-D coupled together. The first connectors 41 are similar on all the containers 10A-D and the second connectors 42 are similar on all the containers 10A-D such that the containers 10A-D can be coupled and decoupled from each other and reorganized into different patterns and/or layouts. Note that the number of containers 10A-D that can be coupled to each other can vary (e.g., forty containers 10 of various sizes and shapes can be coupled to each other and form a desired pattern).

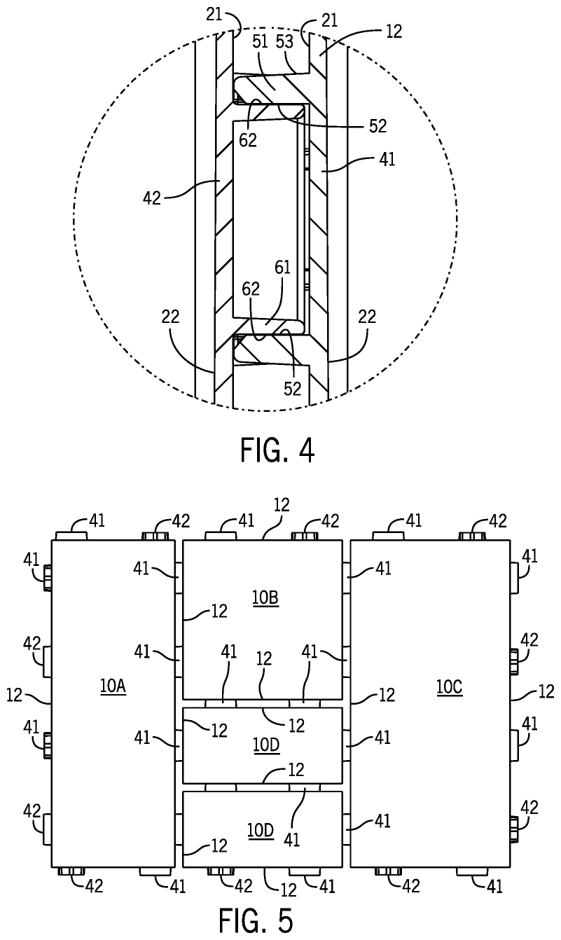

Referring back to FIG. 2 the connectors 41, 42 are depicted in greater detail. The first connector 41 is configured to receive and engage the second connector 42. The first connector 41 may be referred to as a female connector. The first connector 41 has a hole 49 in which the second connector 42 is received. The hole 49 is defined by an annular sidewall 51, and an interior surface 52 borders the hole 49 and an opposite exterior surface 53 faces away from the hole 49. When the first connector 41 couples to the second connector 42, the interior surface 52 of the first connector 41 engages with an exterior surface 62 of the second connector 42 such that friction and/or compression forces between the interior surface 52 and the exterior surface 62 hold the containers 10 together. FIGS. 3-4 depict the first connector 41 coupled to the second connector 24.

The first connector 41 is generally a ring and has the annular sidewall 51. The sidewall 51 and the hole 49 are centered above a center axis 55. The first connector 41 also includes a plurality of ridges 54 that radially extend away from the interior surface 52 into the hole 49. When the second connector 42 is received in the hole 49, the ridges 54 are received in slots 65 defined in the second connector 42 such that the ridges 54 and slots 65 prevent rotation of the connectors 41, 42 relative to each other about the center axis 55 (see arrows E on FIG. 2). The ridges 54 are equidistantly spaced apart along the interior surface 52.

The second connector 42 may be referred to as a male connector, and like the first connector 41, the second connector 42 extends or protrudes away from the exterior surface 21 of the sidewall 12. The size and shape of the second connector 42 can vary, and in the example depicted, the second connector 42 is a ring and has an annular sidewall 61 and a hole 63 both centered about a center axis 64. Note that in another example, the second connector 42 is a cross or “X”-shaped. When the second connector 42 is received in the hole 49 of the first connector 41, an exterior surface 53 of the second connector 42 engages the interior surface 52 of the first connector 41. The exterior diameter F1 (FIG. 2) of the second connector 42 is less than or equal to an interior diameter F2 (FIG. 2) of the first connector 41 such that the second connector 42 is received in the hole 49 of the first connector 41.

As noted above, the second connector 42 has a one or more slots 65 that receive the ridges 54 of the first connector 41 to thereby prevent rotation of the container 10 about the center axis 64. Note that when the second connector 42 is in the hole 49 of the first connector 41, the center axes 55, 64 align with each other. The slots 65 are recessed into the exterior surface 62 of the second connector 42, and the slots 65 are equidistantly spaced apart along the exterior surface 62.

Referring now to FIGS. 5-6, a variety of differently sized and shaped containers 10A-D are depicted coupled together. Some of the containers 10A, 10B have a plurality of first connectors 41 and a plurality of second connectors 42 such that the first connectors 41 and the second connectors 42 are alternatively spaced apart along the sidewalls 12, such that no two similar connectors 41, 42 are immediately adjacent to each other. A person of ordinary skill in the art will appreciate that alternately spacing the connectors 41, 42 advantageously permits the user to rotate the containers 10A-D such that different sidewalls lie next to each other and still couple the container 10A, 10B to each other. Note that the connectors 41, 42 on opposite sidewalls 12 extend in opposite directions (e.g., the container 10A can be rotated 90.0 degrees such that a different sidewall of the container 10A lies next to the other container 10B). Also note that in some examples the openings 19 (FIG. 2) of the container 10 (see FIG. 2) face the same direction (e.g., the first vertical direction V1 on FIG. 1). Note that in some examples, similar connectors 41, 42 are immediately adjacent to each other.

Other example containers 10C, 10D may have similar connectors 41, 42 positioned adjacent to each other. For example, the container 10C-D with short sidewalls 12 may only have one connector 41, 42 extending from the short sidewall 12. These containers 10C-D can be couple to the other containers 10A, 10B, but the user must take care to correctly orient the connectors 41, 42 of the container 10C-D with the connectors 41-, 42 of the other containers 10A, 10B.

A person of ordinary skill in the art will appreciate that if the containers were flipped or invested such that the opening 19 (FIG. 1) of one of the containers 10A-DC was facing an opposite direction as the opening 19 of another container 10A-D, the first connectors 41 would still be capable of coupling to second connectors 42 on the other container 10A-D. However, the containers 10A-D would be slightly laterally or longitudinally offset from each other.

Citations to a number of references are made herein. The cited references are incorporated by reference herein in their entireties. In the event that there is an inconsistency between a definition of a term in the specification as compared to a definition of the term in a cited reference, the term should be interpreted based on the definition in the specification.

In the present description, certain terms have been used for brevity, clarity, and understanding. No unnecessary limitations are to be inferred therefrom beyond the requirement of the prior art because such terms are used for descriptive purposes and are intended to be broadly construed. The different apparatuses, systems, and method steps described herein may be used alone or in combination with other apparatuses, systems, and methods. It is to be expected that various equivalents, alternatives and modifications are possible within the scope of the appended claims.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A container assembly comprising:
a first container having a sidewall, a first connector, and a second connector, the first connector and the second connector each extend away from the sidewall; and
a second container having a sidewall, a first connector, and a second connector, the first connector and the second connector each extend away from the sidewall;
wherein the first connector of the first container is mated with the second connector of the second container and the second connector of the first container is mated with the first connector of the second container to thereby couple the first container to the second container; and
wherein each first connector has an interior surface that defines a hole that is centered about a first center axis and a ridge radially inwardly extending from the interior surface into the hole;
wherein each second connector has an exterior surface that engages with the interior surface of one of the first connectors.

2. The container assembly according to claim 1, wherein each second connector has a slot in which the ridge of one of the first connectors is received when the first connector is mated to the second connector to thereby prevent rotation of the first connector relative to the second connector.

3. The container assembly according to claim 2, wherein the ridge is one of a plurality of ridges spaced apart along the interior surfaces of the first connectors and the slot is one of a plurality of slots spaced apart along the exterior surfaces of the second connectors.

4. The container assembly according to claim 3, wherein the ridges in the plurality of ridges are equidistantly spaced apart along the interior surfaces of the first connectors and the slots in the plurality of slots are equidistantly spaced apart along the exterior surfaces of the second connectors.

5. The container assembly according to claim 1, wherein each first connector is a ring centered about the first center axis, and wherein each second connector has a hole centered about a second center axis such that the second connector is a ring.

6. The container assembly according to claim 5, wherein when the first connector is mated to the second connector, the first center axis is aligned with the second center axis.

7. The container assembly according to claim 5, wherein each first connector has an annular sidewall, and wherein each second connector has an annular sidewall.

8. The container assembly according to claim 1, wherein an exterior diameter of each second connector is less than or equal to an interior diameter of each first connector such that the second connector is received in the hole of one of the first connectors.

9. The container assembly according to claim 1, wherein the first container has a cavity configured to receive objects therein and an opening into the cavity;
wherein the second container has a cavity configured to receive objects therein and an opening into the cavity;
wherein when the first container is coupled to the second container, the opening of the first container and the opening of the second container face a first direction.

10. The container assembly according to claim 9, wherein the second container has a cover that is movable relative to the opening to thereby cover the opening of the second container.

11. The container assembly according to claim 10, wherein the second container has a lip that retains the cover on the second container and permits the cover to slide relative to the opening.

12. A container comprising:
a first sidewall with a first top edge and a first rib vertically extending from the top edge and an opposite second sidewall with a second top edge and a second rib vertically extending from the top edge;
a first connector laterally extending from the first sidewall, wherein the first connector is configured to be mated to a second connector of another container;
a second connector laterally extending from the first sidewall, the second connector spaced apart from the first connector, and wherein the second connector is configured to be mated to a first connector of another container;
a first lip extending from the first sidewall, wherein the first lip and the first top edge at least partially define a first channel therebetween in which the first rib vertically extends;
a second lip extending from the second sidewall, wherein the second lip and the second top edge at least partially define a second channel therebetween in which the second rib vertically extends;
a cavity configured to receive objects therein;
an opening into the cavity; and
a cover that is longitudinally movable in the first channel and the second channel to selectively cover the opening;
wherein the cover has a third rib positioned in the first channel that extends toward the first rib and a fourth rib positioned in the second channel that extends toward the second rib
wherein the third rib contacts the first rib and the fourth rib contacts the second rib to thereby prevent the cover from inadvertently sliding out of the first channel and the second channel.

13. The container according to claim 12, wherein the first lip and the second lip are U-shaped.

14. The container according to claim 12, wherein the first lip and the second lip prevent lateral movement of the cover.

15. The container according to claim 14, wherein the first lip laterally extends in a first lateral direction from the first sidewall and the second lip laterally extends in an opposite second lateral direction from the second sidewall.

16. The container according to claim 12, wherein the first rib and the second rib extend in a first vertical direction, and wherein the third rib and the fourth rib extend in a second vertical direction that is opposite the first vertical direction.

17. The container according to claim 16, further comprising a third sidewall that coupled to and extends transverse to the first sidewall and the second sidewall; and
wherein the cover has a tab that extends in the first vertical direction and contacts the third sidewall as the cover is longitudinally moved to thereby prevent the cover from inadvertently sliding out of the first channel and the second channel.

18. The container assembly according to claim 1, wherein when the first connector of the first container is mated with the second connector of the second container, the first connector of the first container contacts an exterior surface of the sidewall of the second container.
